(19) United States
(12) Patent Application Publication
(10) Pub. No.: US 2015/0132625 A1
(43) Pub. Date: May 14, 2015

(54) SEALED SECONDARY BATTERY

(71) Applicant: SANYO Electric Co., Ltd., Moriguchi-shi, Osaka (JP)

(72) Inventors: Kyosuke Miyata, Osaka (JP); Koki Inoue, Osaka (JP)

(73) Assignee: SANYO Electric Co., Ltd., Moriguchi-shi, Osaka (JP)

(21) Appl. No.: 14/397,703

(22) PCT Filed: Sep. 18, 2013
(86) PCT No.: PCT/JP2013/005505

§ 371 Date: Oct. 29, 2014

(30) Foreign Application Priority Data
Sep. 24, 2012 (JP) 2012-209480

(51) Int. Cl. H01M 2/02; H01M 4/131; H01M 10/04

(52) U.S. Cl. CPC H01M 2/022; H01M 10/0431; H01M 4/131; H01M 2004/028
USPC 429/94

(57) ABSTRACT

A sealed secondary battery comprises a bottomed cylindrical battery case having an opening, a sealing member sealing the opening of the battery case, and a spiral electrode assembly in which a positive electrode plate and a negative electrode plate are wound with a separator interposed therebetween, and an annular thin portion is formed in the bottom of the battery case, and the ratio of the area of a region surrounded by the annular thin portion to the area of the bottom portion of the battery case is equal to or more than 10%, and a volume energy density is equal to or more than 500 Wh/L.

### TECHNICAL FIELD

The present invention relates to a sealed secondary battery including a safety valve through which the gas generated in the battery is discharged outside the battery when the pressure in the battery increases.

### BACKGROUND ART

A sealed secondary battery such as a non-aqueous electrolyte secondary battery represented by a lithium ion secondary battery has been used for the drive power sources of portable electronic equipment such as mobile telephones, portable personal computers, and portable music players, and further for the power sources of electric vehicles (EVs) and hybrid electric vehicles (HEVs).

In the sealed secondary battery, the gas is rapidly generated due to a rapid charge/discharge reaction or chemical reaction in the battery when an internal or external short circuit occurs, or when the battery experiences abnormal heat generation or impact. Accordingly, there is a possibility that the battery may swell or explode. Therefore, most of the sealed secondary battery is provided with a safety valve (an explosion-proof mechanism) through which the gas generated in the battery is discharged outside the battery when the pressure in the battery reaches a predetermined value.

Patent Document 1 mentioned below describes a sealed secondary battery including a safety valve disposed in a sealing member with a valve element, and a safety valve disposed in a battery case with a thin portion. According to the technology of Patent Document 1, the breaking pressure of the thin portion is higher than that of the valve element. Thus, when the gas is generated slowly, the breakage of the safety element can allow the gas to be discharged easily alone, thereby suppressing the increase in battery temperature. On the other hand, when the gas is generated rapidly, the breakage of the thin portion of the battery case can allow the gas to be discharged easily, thereby preventing the break of the battery case.

### CITATION LIST

### Patent Literature

Patent Literature 1:

Japanese Laid-Open Patent Publication No. 1994(=HE106)-333548

### SUMMARY OF THE INVENTION

As the energy density of the sealed secondary battery is increased, the probability that the pressure and the temperature in the battery are rapidly increased at the time of occurrence of an abnormality in the battery is increasing. Thus the gas is not adequately discharged outside through the conventional safety valve. There is a problem that a sealing member is scattered or a crack occurs in a tubular portion of the battery case. Especially, in a battery pack containing plural sealed secondary batteries, a crack in the tubular portion of the battery case might cause emission of the high temperature gas from an unintended portion, leading to the abnormality of the adjacent sealed secondary batteries.

The present disclosure is developed for solving the aforementioned problems, and aims to provide a sealed secondary battery in which an occurrence of a crack in a battery case is suppressed even though the sealed secondary battery has a high energy density.

A sealed secondary battery in the present disclosure comprises a battery case having a tubular shape, an opening thereof, and a bottom portion thereof, a sealing member sealing the opening of the battery case, and a spiral electrode assembly winding a positive electrode plate and a negative electrode plate interposing a separator therebetween, and an annular thin portion is formed in the bottom of the battery case, and the ratio of the area of a region surrounded by the annular thin portion to the area of the bottom portion of the battery case is equal to or more than 10%, and a volume energy density is equal to or more than 500 Wh/L.

Accordingly, even in the sealed secondary battery having the volume energy density of equal to or more than 500 Wh/L, and even at the time that a pressure in the battery is rapidly increased, a crack can be suppressed. The ratio of the area of the region surrounded by the annular thin portion to the area of the bottom portion of the battery case is preferably equal to or more than 10%.

The annular thin portion can be a circle shape such as a true circle shape, an ellipse shape, or the like in the plan view, further a polygonal shape, or a track shape. Especially, the thin portion of a circular shape is preferable, and the thin portion of a true circle shape is more preferable.

A lead connected to the positive or negative electrode plate is connected to a battery inner surface of the region surrounded by the annular thin portion, and a melting point of the lead is preferably equal to or more than 1000° C. Accordingly, even when the annular thin portion placed in the bottom of the battery case breaks due to the increase in the pressure in the battery, the lead is connected to the battery inner surface of the region surrounded by the annular thin portion and the lead does not melt by the high temperature gas. Therefore, it is prevented that the region surrounded by the annular thin portion scatters hard outside the battery. The lead with a melting point of equal to or more than 1000° C., for example, includes nickel, nickel alloy, copper, and copper alloy.

The positive electrode plate contains a positive electrode active material, and the positive electrode active material preferably includes a lithium nickel composite oxide expressed by LiₓNi_{y}M_{1-y}O₂ (0.95≦x≦1.15, 0.6≦y≦1, and M is at least one element selected from the group consisting of Co, Mn, Cr, Fe, W, Mg, Zr, Ti, and Al).

The use of the lithium nickel composite oxide as the positive electrode active material results in obtaining the battery of the high energy density, compared with the use of a lithium cobalt oxide. However, since the use of the lithium transition-metal composite oxide as the positive electrode active material results in the increase in the gas generated in the battery at the time of the battery abnormality and the pressure in the battery is easy to increase rapidly, the problems of the scatter of the sealing member and the crack of the battery case often occurs. Therefore, when the lithium nickel composite oxide as the positive electrode active material is used, the configuration according to the present disclosure is especially effective.

The thin portion is preferably constituted by providing a notch in the outer surface of the bottom of the battery case. Further, it is preferable that the sectional shape of the notch be approximately V-shaped.

It is preferable that the sealing member contain a filter having an opening and the area of the opening of the filter be equal to or more than 30 mm². Here, the area of the opening of the filter is defined as the area of the opening of the filter in the plan view. Further, when the filter has the plural openings, it is preferable the total area of all the openings be equal to or more than 30 mm². By this configuration, the gas generated in the battery is easily exhausted also from the sealing member side to the outside of the battery.

It is preferable that the battery case be made of iron and the thickness of a tubular portion of the battery case is 0.1 mm to 0.4 mm. Such a configuration effectively prevents the occurrence of the crack at the tubular portion of the battery case. Here, it is preferable that a nickel layer be formed on the surface of the battery case made of iron.

A wire is preferably connected to the battery outer surface of the region surrounded by the annular thin portion.

In the battery pack containing a plurality of the sealed secondary batteries, in order to electrically connect the sealed secondary batteries to each other, a conducting member is connected to each of the sealed secondary batteries. In the structure in which the conducting member having a board shape is connected to the battery case, the disclosed effect is obtained, but there is a possibility that the break of the annular thin portion by the increased pressure in the battery is prevented. In the contrast, in the structure in which the wire as the conducting member is connected to the battery outer surface of the region surrounded by the annular thin portion, the break of the annular thin portion is hardly prevented. In addition, it is prevented that the region surrounded by the annular thin portion scatters hard outside the battery. In the battery pack containing a plurality of the sealed secondary batteries of the present disclosure, it is preferable that a holding member which holds each of the batteries have a shape which covers the tubular portion (side surface portion) of the sealed secondary battery.

### BRIEF DESCRIPTION OF DRAWINGS

FIG. 1 is a perspective view of a sealed secondary battery in an embodiment of the present invention.

FIG. 2 is a sectional view of the sealed secondary battery in the embodiment of the present invention.

FIG. 3 is a bottom view of the outside of the sealed secondary battery in the embodiment of the present invention.

FIG. 4 is a bottom view of the inside of the sealed secondary battery in the embodiment of the present invention.

FIG. 5 is a bottom view of the outside of the sealed secondary battery in a comparative example.

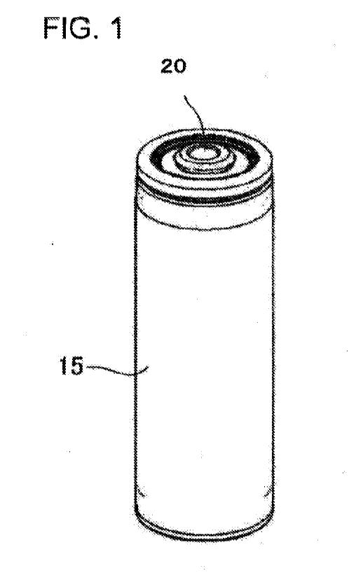

### DESCRIPTION OF EMBODIMENTS

Hereinafter, exemplary embodiments of the present invention will be described in detail with examples, comparative examples, and figures. However, the examples described below is an illustrative example of a lithium ion battery as a sealed secondary battery for embodying the technical concept of the invention, is not intended to the invention to the examples, and may be equally applied to other exemplary embodiments included in the appended claims.

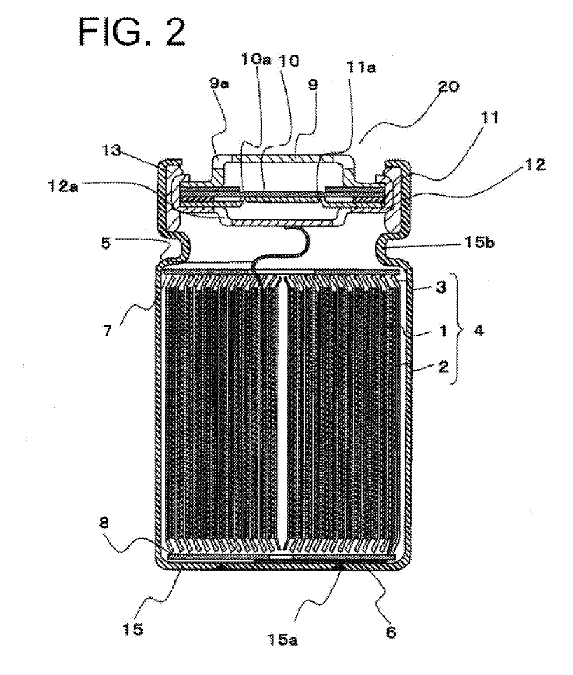

First, the sealed secondary battery as an example is explained with FIG. 2. As shown in FIG. 2, an electrode assembly 4 in which a positive electrode plate 1 and a negative electrode plate 2 are wound with a separator 3 interposed therebetween is stored in a bottomed cylindrical battery case 15 along with a non-aqueous electrolyte (not shown in figures). Insulating boards 7, 8 having a ring shape are respectively disposed on the upper side and lower side of the electrode assembly 4. The positive electrode plate 1 is connected to a filter 12 through a positive electrode lead 5, and the negative electrode plate 2 is connected to the bottom portion of the battery case 15, which also works as a negative electrode terminal through a negative electrode lead 6. The filter 12 is provided with an opening 12a. Here, the area of the opening 12a is preferably 30 mm² in the view from above.

The filter 12 is connected to an inner cap 11, and the projecting portion of the inner cap 11 is coupled to a valve member 10 made of a metal. Further, the valve member 10 is connected to a sealing plate 9, which also works as a positive electrode terminal. The sealing plate 9, the valve member 10, the inner cap 11, and the filter 12 constitute a sealing member 20, and through a gasket 13 the sealing member 20 seals an opening of the battery case 15. However, the sealing member 20 does not necessarily include all of the sealing plate 9, the valve member 10, the inner cap 11, and the filter 12, as long as it can seal the opening of the battery case.

The valve member 10 and the inner cap 11 respectively have a thin portion 10a and a thin portion 11 a which break at the time that the pressure in the battery reaches a predetermined value. The sealing plate 9 has an exhaust hole 9a which exhausts a gas generated in the battery to the outside of the battery through the broken valve member 10 and inner cap 11. The valve member 10, the inner cap 11, and the exhaust hole 9a constitute a safety valve. Here, in the present invention, the safety valve is not necessarily provided at the sealing member, but the safety valve is preferably provided at the sealing member. When the safety valve is provided at the sealing member, the thin portion may be formed only at the valve member 10 and an opening may be provided at the inner cap 11. Alternatively, it is possible that the inner cap is omitted, and the filter 12 is directly coupled to the valve member 10. Furthermore, it is possible that the filer 12 and the inner cap 11 are omitted and the valve member is directly coupled to the positive electrode lead 5.

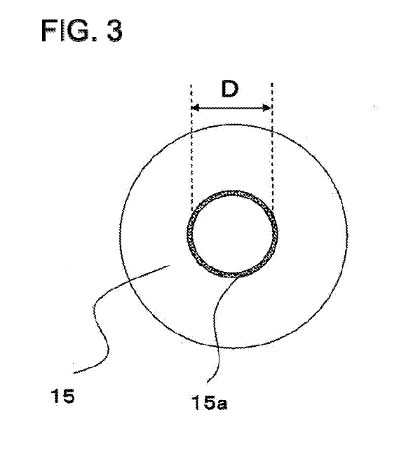

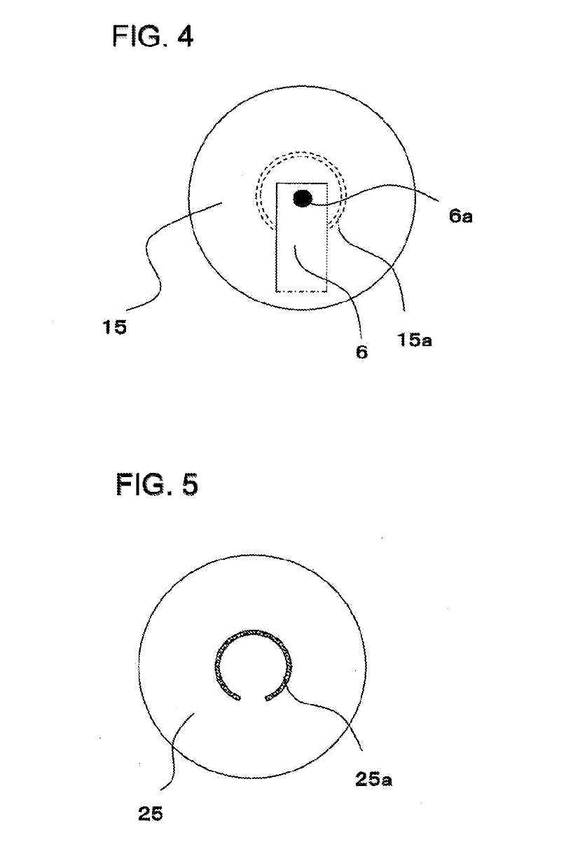

In addition, as shown in FIG. 3, at the bottom portion of the battery case 15, the circular thin portion 15a which breaks at the time that a pressure in the battery reaches a predetermined value is provided. The circular thin portion 15 formed at the bottom portion of the battery case 15 constitutes the safety valve.

When the sealing member is also provided with the safety valve, it is preferable that the breaking pressure of the thin part 15a formed at the bottom portion of the battery case be higher than that of the thin portion 10a formed at the valve member 10. Namely, it is preferable that the operating pressure of the safety valve placed at the bottom portion of the battery case is higher than that of the safety valve placed at the sealing member.

Next, a manufacturing method of the sealed secondary battery is explained.

### Preparation of Positive Electrode Plate

LiNi_{0.8}Co_{0.15}Al_{0.05}O₂ as a positive electrode active material, acetylene black as a conductive agent, polyvinylidene fluoride as a binder were mixed in the ratio of 94:1.6:4 by mass. The resultant mixture was dispersed in N-methyl-2-pyrrolidone to make a positive electrode mixture slurry. This positive electrode mixture slurry was uniformly coated on both surfaces of a positive electrode core made of an aluminum foil (15 μm (=micrometer) in thickness) and dried by heating to prepare a dried electrode plate with an active material layer formed on the aluminum foil. The dried electrode plate was pressed with a roll press so as to have a thickness of 163 μm and cut so as to have a positive electrode core exposed portion without the active material, to prepare a positive electrode plate 1 with a width of 58 mm and a length of 660 mm. After that, a positive electrode lead 5 made of aluminum was connected to the core exposed portion of the positive electrode plate 1 by ultrasonic-welding.

### Preparation of Negative Electrode Plate

Graphite as a negative electrode active material, styrene-butadiene rubber as a binder, and carboxymethylcellulose (CMC) as a thickener were mixed in the ratio of 98.4:0.6:1 by mass, and the mixture was dispersed in water to make a negative electrode mixture slurry. After that, this negative electrode mixture slurry was uniformly coated on both surfaces of a negative electrode core made of a copper foil (10 μm (=micrometer) in thickness) and dried by heating to prepare a dried electrode plate with an active material layer formed on the copper foil. The dried electrode plate was pressed with a roll press so as to have a thickness of 164 μm and cut so as to have a negative electrode core exposed portion without the active material, to prepare a negative electrode plate 2 with a width of 59 mm and a length of 730 mm. After that, a negative electrode lead 6 made of nickel was connected to the core exposed portion of the negative electrode plate 2 by ultrasonic-welding.

### Preparation of Electrode Assembly

The above positive electrode plate 1, the above negative electrode plate 2, and a separator made of polyethylene microporous membrane were wound so that the positive electrode plate 1 and the negative electrode plate 2 were insulated by the separator 3 to prepare an electrode assembly 4.

### Preparation of Non-aqueous Electrolyte

Ethylene carbonate, diethyl carbonate, and ethyl methyl carbonate were mixed in the proportion of 20:20:60 by volume (25° C. (degree Celsius) and 1 atmosphere) to prepare a non-aqueous solvent. Lithium hexafluorophosphate (LiPF₆) as an electrolyte salt was dissolved in the solvent to be 1 mol/L.

### Preparation of Battery Case

By the draw forming of a board plated with nickel on the surface of a base material made of iron, the bottomed cylindrical battery case 15 was prepared. Here, the board thickness of the cylindrical portion of the battery case 15 was 0.25 mm, and the board thickness of the bottom portion of the battery case 15 was 0.3 mm. Further, the bottom portion of the battery case 15 was 18 mm in diameter, and as shown in FIG. 3, the circular thin portion 15a of a diameter of D=9 mm was provided at the bottom portion of the battery case 15. The board thickness of the thin portion was 0.25 mm. Here, the ratio of the area of a region surrounded by the annular thin portion 15a to the area of the bottom portion (battery outer side) of the battery case 15 is 25%.

### Assembly of Battery

The electrode assembly 4 was inserted into the battery case 15 so that the disk-shaped insulating plate 8 made of polypropylene was placed between the electrode assembly 4 and the bottom of the battery case 15 And then, the negative electrode lead 6 was connected to the bottom of the battery case 15 by resistance welding. Thus, the welding portion 6a was formed. At this time, as shown in FIG. 3, the tip portion of the negative electrode lead 6 was disposed within the region surrounded by the thin portion 15a. Since the tip portion of the negative electrode lead 6 was set to have a length and a width which did not interfere with thin portion 15a, the operation of the safety valve was hardly inhibited. Moreover, the gas was smoothly discharged. Next, a disk-shaped insulating plate 7 made of polypropylene was placed on the top portion of the electrode assembly 4. In addition, the groove portion 15b having a U-shaped cross-section with a width of 1.0 mm and a depth of 1.5 mm was formed to the opening side rather than the insulating plate 7 in the cylindrical portion of the battery case 15 in the radial direction. Thus, a projecting portion to the inner side of the cylindrical portion of the battery case 15 was formed along the entire circumference. After that, the non-aqueous electrolyte was injected into the battery case 15. Further, the positive electrode lead 5 was connected to the filter 12 which constitutes the sealing member 20 by laser-welding, and the sealing member 20 was disposed on the projecting portion which was formed on the inner side of the cylindrical portion of the battery case 15 in a state in which the positive electrode lead 5 was folded, and the cylindrical portion in the vicinity of the opening of the battery case 15 was swaged, to prepare a sealed secondary battery of the example 1. This sealed secondary battery had the cylindrical shape of 18 mm in diameter and 65 mm in height. The volume of this sealed secondary battery was 0.0165 L. Further, the battery capacity of this sealed secondary battery was 3200 mAh, and the energy capacity was 11.5 Wh in energy capacity. Additionally, the volume energy density was 697 Wh/L.

Here, the battery capacity was obtained in the following way. The sealed secondary battery was charged with a current of 1.0 A to 4.2 V, and after that, it was charged with a constant voltage of 4.2 V for 4 hours. Subsequently, it was discharged with a constant current of 0.6 A to 2.5 V. A discharging capacity obtained at this time was defined as the battery capacity.

### COMPARATIVE EXAMPLE 1

A sealed secondary battery of the comparative example 2 was prepared in the same way as the example except that as a battery case, a circular thin portion of a diameter of D=5 mm was placed at the bottom portion of the battery case. Here, the ratio of the area of a region surrounded by the annular thin portion to the area of the bottom portion of the battery case was 8%.

### COMPARATIVE EXAMPLE 2

A sealed secondary battery of the comparative example 2 was prepared in the same way as the example except that as a battery case, a C-shaped thin portion of a diameter of D=9 mm was placed at the bottom portion of the battery case.

### Heat Test

Ten pieces of the sealed secondary batteries in each of the example 1, the comparative example 1, and the comparative example 2 were prepared, and a heat test was carried out under the following conditions. First, the batteries were charged with a current of 1500 mA to a battery voltage of 4.2V at 25° C. The sealed secondary batteries were put on the hot plate set to 200° C. such that the cylindrical portion of the battery case was in contact with the hot plate, and the batteries were heated at 200° C. And then, the presence or absence of a scatter of the sealing member or a crack of the battery case was inspected. The results are shown in Table 1.

TABLE 1

| | crack occurrence | scatter occurrence |
|---|---|---|
| | rate (%) | rate (%) |
| Example 1 | 0 | 0 |
| Comparative Example 1 | 80 | 0 |
| Comparative Example 2 | 30 | 0 |

In the example 1 in which the circular thin portion of the diameter of D=9 mm was placed at the bottom portion of the battery case, since the gas in the battery was smoothly exhausted due to the opening of the thin portion of the battery case, the sealing member was not scattered and a crack did not occur. In the comparative example 1 in which the circular thin portion of the diameter of D=5 mm was placed at the bottom portion of the battery case, and in the comparative example 1 in which the C-shaped thin portion of the diameter of D=9 mm was placed at the bottom portion of the battery case, the sealing member was not scattered, but cracks occurred. The crack occurrence rates of the battery case were 80% in the comparative example 1 and 30% in the comparative example 2. It is likely that in the sealed secondary battery of the comparative example 1 and the comparative example 2, cracks of the cylindrical portion of the battery case occurred since the gas generated in the battery was not smoothly exhausted outside the battery. In the sealed secondary battery of the embodiment, by specifying the shape of the thin portion at the bottom portion of the battery case and the ratio of the area of the region surrounded by the thin portion to the area of the bottom portion of the battery case are specified, the sealed secondary battery can be provided which prevents the crack of the cylindrical portion of the battery case and is excellent in safety.

In the above example, as the sealed secondary battery, a lithium ion secondary battery of the non-aqueous electrolyte secondary battery has been explained. Even the sealed secondary battery like an alkaline storage battery other than the non-aqueous electrolyte secondary battery can obtain the same effect. Especially, the present disclosure is effective for the non-aqueous electrolyte secondary battery. Further, although the above example used a circular shape for the thin portion at the bottom portion of the battery case, a polygonal shape or the like can be used. Furthermore, a recessed portion can be placed in the inside surface of the battery case.

In the present disclosure, as the positive electrode active material, a lithium transition-metal composite oxide, a lithium transition-metal phosphate compound having an olivine structure, and the like are preferable. As the lithium transition-metal composite oxide, a lithium-cobalt composite oxide, a lithium-nickel composite oxide, a lithium-nickel-cobalt composite oxide, a lithium-nickel-cobalt-manganese composite oxide, a spinel type lithium manganese composite oxide, and a compound by substituting a part of transition-metal elements contained in these compounds with other metal elements (Zr, Mg, Ti, Al, W, or the like) are preferable. Further, as the lithium transition-metal phosphate compound having an olivine structure, a lithium iron phosphate is preferable. These may be used singly or as a mixture of two or more of them.

In the present disclosure, as the negative electrode active material, a material which can reversibly adsorb and desorb lithium ions is used. For example, carbon materials, such as, natural graphite, artificial graphite, hardly-graphitizable carbon (hard carbon), easily-graphitizable carbon (soft carbon), and the like, metal oxides, such as, tin oxide, silicon oxide and the like, or silicon containing compounds, such as, silicon, silicide, and the like can be used.

In the present disclosure, as the separator, a polyolefin material is preferably used. A combination of a polyolefin material and a heat-resistant material is more preferably used. Examples of a polyolefin material include a polyethylene porous membrane, a polypropylene porous membrane, and an ethylene-propylene copolymer porous membrane. These can be used singly, or as a combination of two or more of them. As a heat-resistant material, a porous membrane made of a heat resistant resin, such as, aramid, polyimide, polyamide-imide, and the like, or a mixture of a heat-resistant resin and an inorganic filler can be used.

In the present disclosure, as the non-aqueous solvent of the non-aqueous electrolyte, cyclic carbonates, such as ethylene carbonate, propylene carbonate, and butylene carbonate, or the like, chain carbonates, such as diethyl carbonate, ethyl methyl carbonate, dimethyl carbonate, or the like, lactones, such as, γ-butyrolactone (γ-BL) and γ-valerolactone (γ-VL) or the like , carboxylic esters, such as, methyl pivalate, ethyl pivalate, methyl isobutyrate, and methyl propionate or the like can be used. These are used singly, or as a mixture of two or more of them.

In the present disclosure, as the electrolyte salt of the non-aqueous electrolyte, LiCLO₄, LiCF₃SO₃, LiPF₆, LiBF₆, LiAsF₆, LiN (CF₃SO₂₎₂, LiN (CF₂CF₃SO₂)₂, or the like can be used. These are used singly or as a mixture of two or more of them. The concentration of electrolyte salt dissolved in the non-aqueous solvent is preferably 0.5 to 2.0 mol/L.

### REFERENCE MARKS IN THE DRAWINGS

1: positive electrode plate

2: negative electrode plate

3: separator

4: electrode assembly

5: positive electrode lead

6: negative electrode lead

7,8: insulating plate

9: sealing plate

9a: exhausting hole

10: valve member

10a: thin portion

11: inner cap

11a: thin portion

12: filter

12a: opening

13: gasket

15: battery case

15a: thin portion

15b: groove portion

20: sealing member

1. A sealed secondary battery comprising:
a bottomed cylindrical battery case having an opening;
a sealing member sealing the opening of the battery case; and
a spiral electrode assembly in which a positive electrode plate and a negative electrode plate are wound with a separator interposed therebetween,
wherein an annular thin portion is formed in the bottom of the battery case, and the ratio of the area of a region surrounded by the annular thin portion to the area of the bottom portion of the battery case is equal to or more than 10%, and a volume energy density is equal to or more than 500 Wh/L.

2. The sealed secondary battery according to claim 1,
wherein a lead connected to the positive or negative electrode plate is connected to a battery inner surface of the region surrounded by the annular thin portion, and a melting point of the lead is equal to or more than 1000° C.

3. The sealed secondary battery according to claim 1, wherein the positive electrode plate contains a positive electrode active material, and the positive electrode active material is a lithium nickel composite oxide expressed by LiₓNi_{y}M_{1-y}O₂ (0.95≦x≦1.15, 0.6≦y≦1, and M is at least one element selected from the group consisting of Co, Mn, Cr, Fe, W, Mg, Ti, and Al).

4. The sealed secondary battery according to claim 1, wherein the thin portion is a notch which is provided in the outer surface of the bottom of the battery case.

5. The sealed secondary battery according to claim 1, wherein the sealing member contains a filter having an opening, and the area of the opening of the filter is equal to or more than 30 mm².

6. The sealed secondary battery according to claim 1, wherein the annular thin portion is circular.

7. The sealed secondary battery according to claim 1, wherein the battery case is made of iron, and the thickness of a cylindrical portion of the battery case is 0.1 mm to 0.4 mm.

8. The sealed secondary battery according to claim 1, wherein a wire is connected to the battery outer surface of the region surrounded by the annular thin portion.
